(19) United States
(12) Patent Application Publication
(10) Pub. No.: US 2011/0082020 A1
(43) Pub. Date: Apr. 7, 2011

(54) DIE FOR EMBOSSING AND CUTTING

(76) Inventor: Lai Chu Tsai, Yilan City (TW)

(21) Appl. No.: 12/614,596

(22) Filed: Nov. 9, 2009

(30) Foreign Application Priority Data
Oct. 5, 2009 (TW) 098218292

(51) Int. Cl. B31F 1/07

(52) U.S. Cl. 493/324

(57) ABSTRACT

A cutting die includes two plastic templates detachably coupled to each other and having patterns formed thereon. At least one of the patterns is provided with a cutting portion for allowing the cutting operation to be performed while imprinting a desired pattern by folding the two plastic templates relative to each other, thereby dispensing with the cutting step otherwise performed after the pattern is imprinted.

### BACKGROUND OF THE INVENTION

1. Field of the Invention

The present invention relates generally to embossing dies, and more particularly to an embossing die with a cutting function.

2. Description of Related Art

Embossing dies used in the handicrafts industry mainly involve imprinting certain patterns or characters on sheet materials such as paper, films, foam, soft magnets, photos, leather and cloth, or imprinting embossing patterns or characters on the surface of the sheet materials, which are generally used for fabricating cards, photo albums or packaging materials.

A conventional method for fabricating an embossing die involves etching a metal material to form a group of metal templates with patterns thereof corresponding to each other (metal templates with corresponding concave and convex portions), and adhering the two metal templates to a foldable plastic board. As such, the user only needs to fold the plastic board so as to imprint a three-dimensional embossing pattern on a piece of paper.

FIGS. 1A and 1B show a conventional embossing die. Referring to FIGS. 1A and 1B, the embossing die comprises a first frame 10a having a first embossing surface 101a, a second frame 10b having a second embossing surface 101b, a first metal template 11a adhered to the first embossing surface 101a and a second metal template lib adhered to the second embossing surface 101b. The first and second frames 10a, 10b are made of plastic and bonded together by hot melting. The first and second metal templates 11a, 11b are adhered to the first and second embossing surfaces 101a, 101b through a double-sided adhesive and have first and second patterns 110a, 110b, respectively.

To use the conventional embossing die, the user puts a piece of paper on the first metal template 11a or the second metal template 11b and then folds up the first frame 10a and the second frame 10b such that the first pattern 110a and the second pattern 110b are aligned with each other and pressed against the piece of paper at the same time, thereby imprinting a three-dimensional embossing pattern on a piece of paper.

However, etching is required for forming the patterns of the first and second metal templates 11a, 11b, which is time-consuming and costly and accordingly is not suitable for industry application.

Further, a cutting step using a knife or scissors is usually needed after an embossing pattern is imprinted so as to trim the embossing pattern, which is rather time-consuming and laborious and accordingly is not suitable for industry application.

Therefore, it is imperative to provide a cutting die to overcome the above-described drawbacks of the prior art.

### SUMMARY OF THE INVENTION

In view of the above drawbacks of the prior art, it is an objective of the present invention to provide a cutting die for allowing a cutting operation and the embossing operation to be concurrently performed to thereby enhance the application value of the cutting die.

Another objective of the present invention is to provide a cutting die conducive to reduction of manufacturing costs.

In order to achieve the above and other objectives, the present invention provides a cutting die comprising a first plastic template and a second plastic template detachably coupled to each other, the cutting die is characterized in that: a first pattern and a third pattern are formed on a surface of the first plastic template and a surface of the second plastic template, respectively, so as for the first pattern and the third pattern to correspond in position to each other and be foldable together, and at least one of the first pattern and the third pattern is provided with a cutting portion configured for hole-punching.

The cutting portion is a carbon steel knife, and detachably disposed on the pattern. The first plastic template is coupled to the second plastic template through a bi-directionally foldable means such that the first and second plastic templates can be bi-directionally folded relative to each other

The cutting die further comprises a first frame and a second frame that are detachably coupled to each other and have bases formed on opposite surfaces thereof so as for the first and second plastic templates to be disengageably disposed on the bases of the first and second frames, respectively. The bases are groove-shaped, and the bottom of each of the grooves is defined as an embossing surface.

The first and second frames can be coupled together through a hinge such that the first and second frames can be folded relative to each other.

The first and second plastic templates can be disengageably disposed on the bases of the first and second frames through an attracting means or an engaging means.

According to another embodiment, a second pattern is formed on another surface of the first plastic template, and a fourth pattern is formed on another surface of the second plastic template to be correspondingly assembled to the second pattern. Further, the cutting portion is formed on at least one of the second pattern and the fourth pattern.

The plastic templates of the present invention reduce the fabrication cost compared with the conventional metal templates. Further, the cutting portion of the present invention allows the cutting operation to be performed while the embossing operation is performed so as to dispense with the cutting step that is performed after the pattern is imprinted in the prior art, thereby improving the application properties of the cutting die.

### BRIEF DESCRIPTION OF DRAWINGS

FIG. 1A is a top view of a conventional embossing die;

FIG. 1B is a sectional view of the conventional embossing die before pressing;

FIG. 2A is a top view of a cutting die according to a first embodiment of the present invention;

FIG. 2B is a sectional view of the disassembled cutting die before pressing according to the first embodiment of the present invention;

FIG. 3A is a top view of the cutting die according to a second embodiment of the present invention;

FIG. 3B is a sectional view of the cutting die before pressing according to the second embodiment of the present invention;

FIG. 4 is a perspective view of the cutting die according to a third embodiment of the present invention;

FIG. 5A is a top view of the cutting die according to a fourth embodiment of the present invention; and

FIG. 5B is a sectional view of the cutting die before pressing according to the fourth embodiment of the present invention.

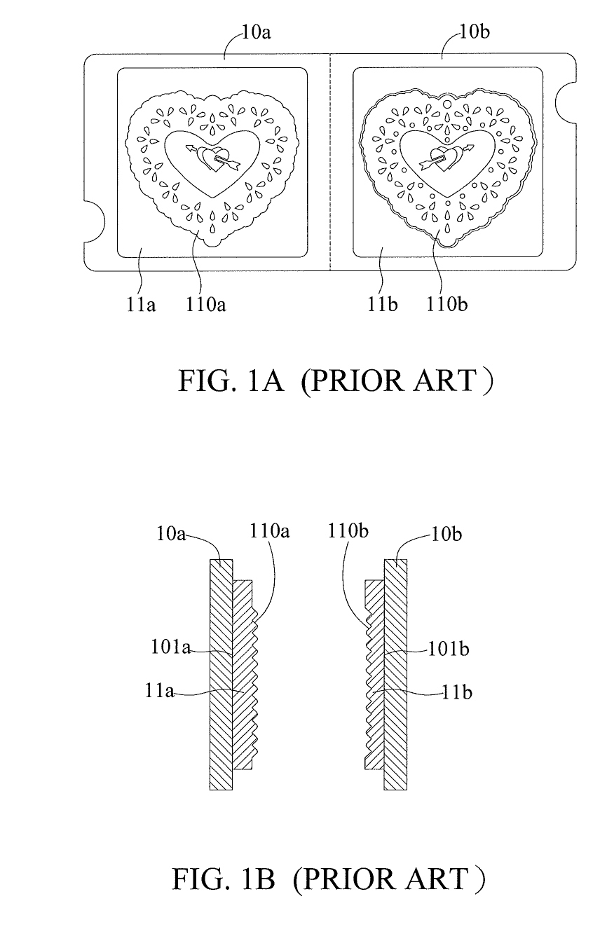

### DETAILED DESCRIPTION OF PREFERRED EMBODIMENTS

The following illustrative embodiments are provided to illustrate the disclosure of the present invention, these and other advantages and effects can be apparent to those skilled in the art after reading the disclosure of this specification.

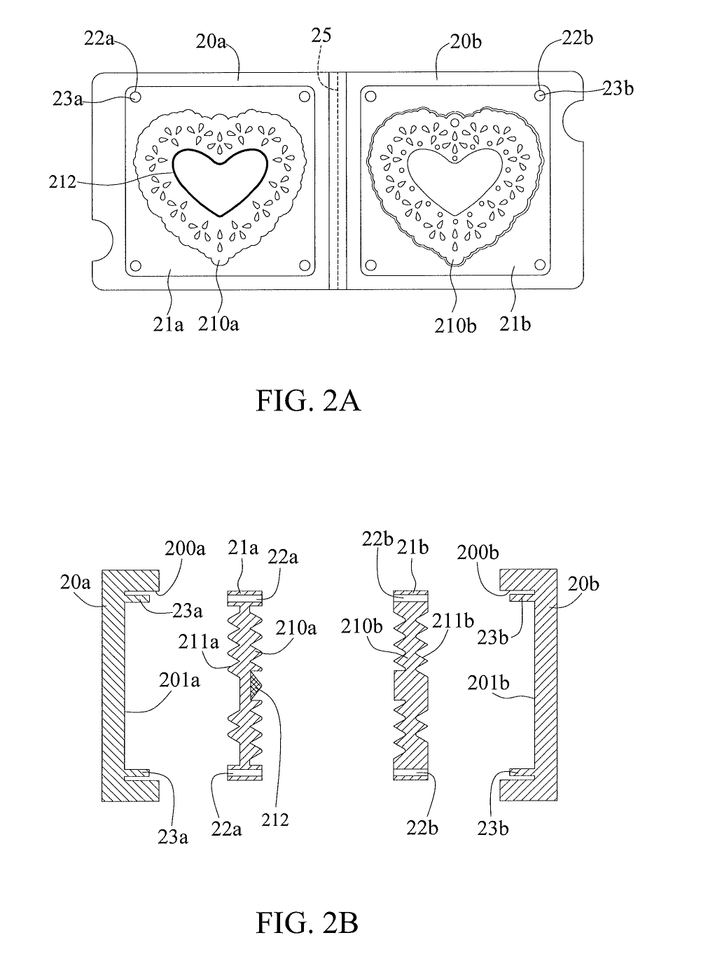

FIGS. 2A and 2B show a cutting die according to a first embodiment of the present invention. The cutting die comprises: a first frame 20a and a second frame 20b detachably coupled to each other, a first plastic template 21a and a second plastic template 21b detachably coupled to each other, and a cutting portion 212 configured for hole-punching.

The first frame 20a has a groove-shaped first base 200a with a first embossing surface 201a defined on the bottom thereof.

The second frame 20b has a groove-shaped second base 200b with a second embossing surface 201b defined on the bottom thereof and corresponding to the first embossing surface 201a such that the second embossing surface 201b can be covered with the first embossing surface 201a.

Preferably, the second frame 20b is coupled to the first frame 20a through a bending structure 25, such as a hinge, such that the first frame 20a and the second frame 20b can be folded together so as to allow the second embossing surface 201b to be covered with the first embossing surface 201a. A wide variety of bending structures are previously disclosed in the art, but the conventional bending structures are not considered an essential technical feature of the present invention, and thus detailed description of the conventional bending structures is omitted herein. Further, a material of which the frames are made can be selected, depending on the plastic templates; and there is no special limit to the material according to the present invention.

The first plastic template 21a is detachably disposed on the first embossing surface 201a of the first frame 20a. The first plastic template 21a has two opposite surfaces provided thereon with a first pattern 210a and a second pattern 211a, respectively.

The second plastic template 21b is detachably disposed on the second embossing surface 201b of the second frame 20b. The second plastic template 21b has two opposite surfaces provided thereon with a third pattern 210b and a fourth pattern 211b, respectively. The third pattern 210b and the first pattern 210a correspond in position to each other and are foldable together, so as for a first three-dimensional embossing pattern to be fabricated from the third pattern 210b and the first pattern 210a. The fourth pattern 211b and the second pattern 211a correspond in position to each other and are foldable together, so as for a second three-dimensional embossing pattern to be fabricated from the fourth pattern 211b and the second pattern 211a. The patterns of the plastic templates can be formed by injection molding, which is well known in the art and thus detailed description thereof is omitted herein.

The cutting portion 212 is disposed on the first and third patterns 210a, 210b or/and the second and fourth patterns 211a, 211b. Preferably, the cutting portion 212 is detachably disposed on the pattern, for example, the cutting portion 212 can be adhered to or engaged with the pattern. In the present embodiment, the cutting portion 212 of a heart shape is disposed on the first pattern 210a. Further, the cutting portion 212 is a carbon steel knife configured to facilitate the cutting operation.

In mass production, the first and second plastic templates 21a, 21b can be molded to form desired patterns and then the cutting portion 212 made of carbon steel is adhered to the patterns positioned at portions to be cut, thereby saving time and reducing material costs. Compared with the conventional metal templates, the first and second plastic templates 21a, 21b of the present invention are suitable for mass production and can efficiently reduce the cost.

In the present embodiment, the cutting die further comprises an engaging portion, which comprises an engaging hole 22a disposed on the first plastic template 21a, and an engaging column 23a disposed on the first embossing surface 201a and corresponding in position to the engaging hole 22a. By engaging the engaging hole 22a with the engaging column 23a, the first plastic template 21a can be positioned on the first embossing surface 201a. It should be noted that the engaging hole 22a and the engaging column 23a together provide a positioning function but do not provide an integration function. Therefore, the first plastic template 21a is not integrated with the first embossing surface 201a, but instead is detachable from the first embossing surface 201a.

Further, an engaging hole 22b is disposed on the second plastic template 21b, and an engaging column 23b is disposed on the second embossing surface 201b and corresponding in position to the engaging hole 22b such that when the engaging hole 22b is engaged with the engaging column 23b, the second plastic template 21b can be detachably positioned on the second embossing surface 201b.

To imprint a first three-dimensional embossing pattern of FIG. 2A on such as a piece of paper, the first plastic template 21a is disposed on the first frame 20a with the first pattern 210a facing outwards, and the second plastic template 21b is disposed on the second frame 20b with the third pattern 210b facing outwards. Then, the piece of paper is disposed between the first and second plastic templates 21a, 21b, and the first pattern 210a and the third pattern 210b are aligned with each other and pressed against the piece of paper at the same time, thereby imprinting the first three-dimensional embossing pattern on the piece of paper. In conjunction with the embossing operation, a cutting operation is performed through the cutting portion 212 such that a heart-shaped through hole is formed on the first three-dimensional embossing pattern.

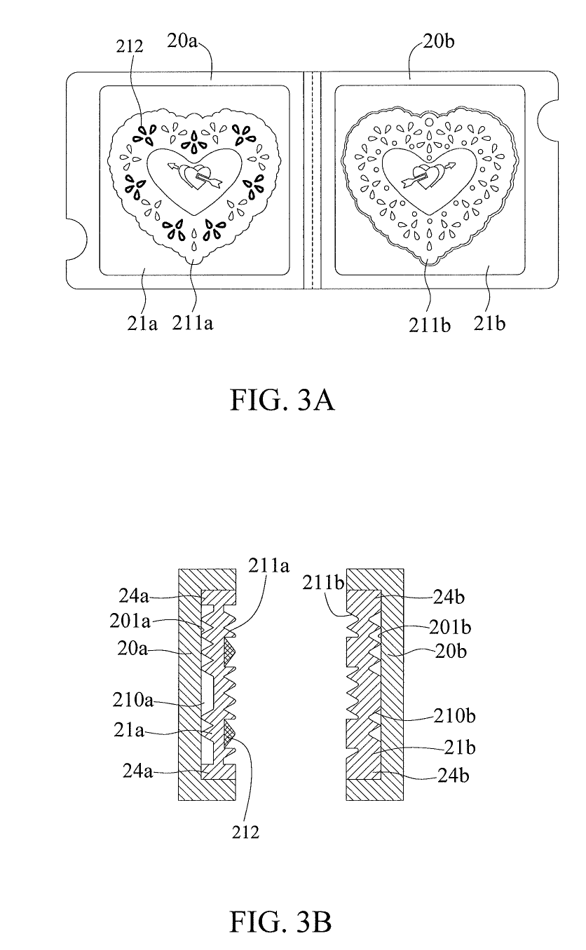

To form a second three-dimensional embossing pattern (referring to patterns of FIG. 3A), the first and second plastic templates 21a, 21b are detached from the first and second frames 20a, 20b and turned over so as for the second and fourth patterns 211a, 211b to face outwards, Then, the second pattern 211a and the fourth pattern 211b are aligned with each other and pressed against a piece of paper at the same time, thereby imprinting the second three-dimensional embossing pattern on the piece of paper. With the cutting portion 212 being absent from the second pattern 211a or the fourth pattern 211b, it is impossible to perform a cutting operation while forming the second three-dimensional embossing pattern and accordingly no through hole is formed on the second three-dimensional embossing pattern.

The present invention discloses at least a plastic template whereby patterns can be formed on two surfaces of the at least a plastic template by injection molding, and thus the present invention saves time and cuts material costs more than the prior art. Further, the cutting portion 212 of the cutting die allows a cutting operation and an embossing operation to be concurrently performed, thereby dispensing with the conventional cutting step otherwise performed after the pattern is imprinted and increasing application value. Furthermore, the plastic templates of the present invention can be used for printing patterns.

FIGS. 3A and 3B show the cutting die according to a second embodiment of the present invention. The second embodiment differs from the first embodiment in terms of the means of positioning the plastic templates on the frames and the shape of the cutting portion. The aforesaid differences are detailed below.

The cutting die further comprises an attracting portion that can be a sucker-type element or a magnetic type element whereby the plastic templates are attracted to the embossing surfaces. In the present embodiment, the attracting portion is, but not limited to, of a magnetic type.

The edge 24a of the first plastic template 21a is attracted to the first embossing surface 201a, and the edge 24b of the second plastic template 21b is attracted to the second embossing surface 201b. Further, the edge 24a of the plastic template can be disposed with a metal material, and the frame is made of a magnetic material. Alternatively, magnets of opposite polarity are disposed on the edges 24a, 24b of the plastic templates and the frames, respectively, such that the plastic templates and the frames attract each other. In the second embodiment, the second and fourth patterns 211a, 211b face outwards for imprinting a pattern.

Furthermore, the cutting portion 212 of a flower shape is disposed on the third pattern 211a of the first plastic template 21a.

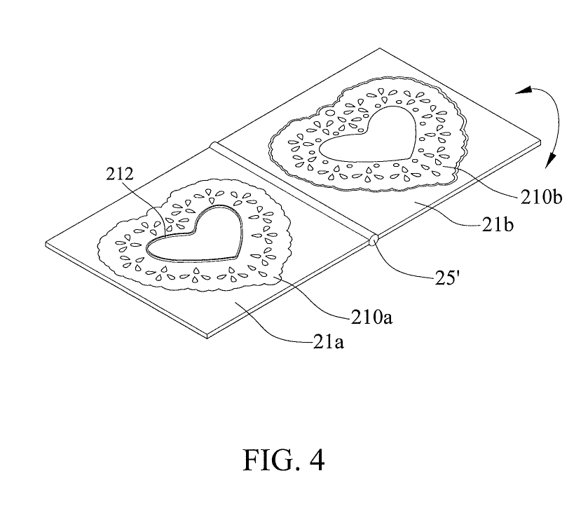

FIG. 4 shows the cutting die according to a third embodiment of the present invention. The third embodiment differs from the first and second embodiments in that, in the third embodiment, frames are dispensed with, and the first and third patterns 210a, 210b are formed on the first and second plastic templates 21a, 21b in a single-sided manner, respectively. The aforesaid differences are detailed below.

The second plastic template 21b is detachably coupled to the first plastic template 21a. The first pattern 210a and the third pattern 210b correspond in position to each other and are foldable together. At least one of the first pattern 210a and the third pattern 210b has a cutting portion 212 disposed thereon. Preferably, the second plastic template 21b is coupled to the first plastic template 21a through a bending structure 25′ such that the first plastic template 21a can be bi-directionally folded to the second plastic template 21b, wherein the bending structure 25′ is a bi-directionally rotatable hinge. A wide variety of bi-directionally rotatable elements are previously disclosed in the art, but the conventional bi-directionally rotatable elements are not considered an essential technical feature of the present invention, and thus detailed description of the conventional bending structures is omitted herein.

The first pattern 210a and the third pattern 210b can be aligned with each other and pressed against a piece of paper at the same time so as to imprint the first three-dimensional embossing pattern on the piece of paper.

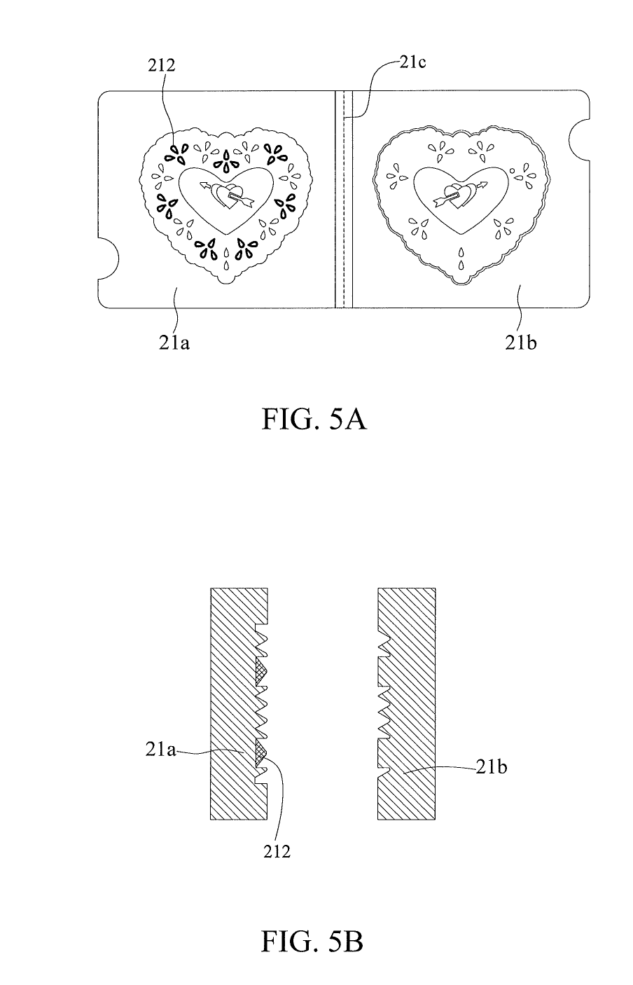

Referring to FIG. 5A and FIG. 5B, there are shown schematic views of the cutting die according to a fourth embodiment of the present invention. The fourth embodiment differs from the third embodiment in that, in the fourth embodiment, the first plastic template 21a and the second plastic template 21b are integrally formed and connected as a unitary structure. The aforesaid difference is detailed below.

The second plastic template 21b is connected to the first plastic template 21a by a connecting portion 21c, so as for the first plastic template 21a to be folded to the second plastic template 21b by means of the connecting portion 21c.

Therefore, the plastic templates of the present invention cut material costs and save time in mass production. Further, the cutting portion of the present invention allows a cutting operation and an embossing operation to be concurrently performed so as to dispense with the conventional cutting step otherwise performed after the pattern in imprinted, thereby improving application value.

The above-described descriptions of the detailed embodiments are intended to illustrate the preferred implementation according to the present invention but not intended to limit the scope of the present invention, Accordingly, all modifications and variations made to the embodiments of the present invention by persons skilled in the art should fall within the scope of present invention defined by the appended claims.

What is claimed is:

1. A cutting die comprising a first plastic template and a second plastic template detachably coupled to each other, the cutting die being characterized in that:
a first pattern and a third pattern are formed on a surface of the first plastic template and a surface of the second plastic template, respectively, so as for the first pattern and the third pattern to correspond in position to each other and be foldable together, and at least one of the first pattern and the third pattern is provided with a cutting portion and configured for hole-punching.

2. The die of claim 1, further comprising a first frame and a second frame detachably coupled to each other and having bases formed on opposite surfaces thereof, so as for the first and second plastic templates to be disengageably disposed on the bases of the first and second frames, respectively.

3. The die of claim 2, wherein the first and second frames are coupled together through a hinge such that the first and second frames can be folded relative to each other.

4. The die of claim 2, wherein the bases are groove-shaped.

5. The die of claim 4, wherein the bottom of each of the grooves is defined as a embossing surface.

6. The die of claim 2, wherein the first and second plastic templates are disposed on the bases of the first and second frames through an attracting means.

7. The die of claim 2, wherein the first and second plastic templates are engaged with the bases of the first and second frames through an engaging means.

8. The die of claim 1, wherein the first plastic template is coupled to the second plastic template through a bi-directionally foldable means such that the first and second plastic templates can be bi-directionally folded relative to each other.

9. The die of claim 1, wherein the cutting portion is a carbon steel knife.

10. The die of claim 1, wherein the cutting portion is disengageably disposed on the pattern.

11. The die of claim 1, wherein a second pattern and a fourth pattern are formed on another surface of the first plastic template and another surface of the second plastic template, respectively, so as for the second pattern and the fourth pattern to correspond in position to each other and be foldable together

12. The die of claim 11, wherein the cutting portion is further formed on at least one of the second pattern and the fourth pattern.
